(19) United States
(12) Patent Application Publication
(10) Pub. No.: US 2003/0088797 A1
(43) Pub. Date: May 8, 2003

(54) Adapting link speed of a network controller to available power supply

(76) Inventor: Daniel Gaur, Beaverton, OR (US)

Correspondence Address: Pillsbury Winthrop LLP, Intellectual Property Group, 725 So. Figueroa Street, Suite 2800, Los Angeles, CA, 90017-5406, US

(21) Appl. No.: 10/045,853

(22) Filed: Nov. 7, 2001

(51) Int. Cl. G06F 1/26

(52) U.S. Cl. 713/300

(57) ABSTRACT

A system and method of adapting the link speed of a network controller to the available power supply is provided. At higher network link speeds, computing systems consume more power. Thus, a network controller of the present invention selects a network adapter link speed in response to the availability and capacity of a local power supply, so as to maximize the longevity of system operation based upon this power supply. The network link speed may be altered in response to a periodic maintenance routine that lowers the link speed when the local power supply is finite in capacity (e.g., a battery or Uninterruptible Power System) and raises the link speed when the local power supply is infinite in capacity (e.g., an AC power source).

### BACKGROUND OF THE INVENTION

1. Field of the Invention

The present invention generally relates to network adapters that support multiple link speeds. More particularly, the present invention relates to a system and method for the selection of a network adapter link speed in response to the availability and capacity of a local power supply, so as to maximize longevity of the power supply.

2. Discussion of the Related Art

Modern network adapters are frequently capable of supporting multiple link speeds. Fast Ethernet controllers typically support operation at either 10 or 100 megabits per second (Mb/s). More recently, network equipment vendors have introduced Ethernet devices capable of operation at 10, 100 and even 1,000 Mb/s. In the process of initializing such a controller, on system start-up or the like, the corresponding device driver of such a controller will typically select the appropriate link speed based solely on the existing network infrastructure or user preference. The user or system-preferred link speed is generally the fastest speed available.

Power consumption is one tradeoff when selecting link speed. Operating at higher speeds provides greater performance, but also requires more power. For instance, a 10/100 network adapter provides greater throughput at 100 Mb/s, but consumes markedly less power at 10 Mb/s.

In many environments, this tradeoff is not significant since power is readily available (e.g., from an AC power source). However, in power-constrained environments (e.g., mobile systems operating on battery power or server systems operating on Uninterruptible Power Systems), this decision directly affects the length of time that the system may continue to operate. Maintaining operation at a high link speed depletes local power reserves more rapidly, resulting in a shorter total period for which the system may function.

Conventional network controllers do not account for the available power source at runtime. Instead, most controllers operate at the highest possible speed, and thus at the highest corresponding level of power consumption at all times. As a result, systems employing conventional network controllers do not make the most efficient use of available power, particularly when the available power source is finite in its capacity.

Accordingly, there is a need for a system and method for adapting the link speed of a network controller in response to the availability and capacity of a local power supply.

### BRIEF DESCRIPTION OF THE DRAWINGS

FIG. 1 illustrates a block diagram of a network controller in a computing system according to an embodiment of the present invention;

FIG. 2 illustrates a flow chart corresponding to the logical implementation according to an embodiment of the present invention; and

FIG. 3 illustrates a graphical representation of the behavior of an embodiment of the present invention.

### DETAILED DESCRIPTION

In one embodiment of the present invention, a system for adapting the link speed of a network controller is provided. The system includes a network device driver that executes a periodic maintenance routine. This routine may determine the availability and/or capacity of a local power supply, and may further select a network link speed that maximizes longevity of the power supply in response thereto.

In another embodiment of the present invention, a method of adapting the link speed of a network controller is provided. The method may include providing a network device driver that executes a periodic maintenance routine. The maintenance routine may first query the system to determine if the system has recently switched to battery power, and, if so, may lower network link speed accordingly. If the system response to the first inquiry is negative (i.e., the system has not recently switched to battery power), the maintenance routine may then secondly query the system to determine if the system has recently switched to AC power, and, if so, may raise or restore higher network link speed accordingly.

In yet another embodiment of the present invention, a machine-readable storage medium with machine-readable program code stored thereon has instructions to adapt the link speed of a network controller. The instructions may be to provide a network device driver that executes a periodic maintenance routine. The maintenance routine may then be instructed to query the system and determine if the system has recently switched to battery power, and, if so, to lower network link speed accordingly. If the answer to the first inquiry is negative (e.g., the system has not recently switched to battery power), the maintenance routine may then be instructed to secondly query the system and determine if the system has recently switched to AC power, and, if so, to raise or restore higher network link speed accordingly.

As used herein, the term “battery” refers to all sources of power for a computing or similar system that are finite in their capacity. This term includes traditional batteries and battery power sources, as well as Uninterruptible Power Systems (“UPS”) and the like.

Also, as used herein, the term “recently,” when used to describe the timing of a change in local power supply as queried by a maintenance routine of the present invention, means any point in time since the last query from the periodic maintenance routine or start up of the computing system, whichever is later.

The present invention prolongs battery life by reducing the demand placed on a local power source by a network controller. As a result, a system may operate for longer periods of time on a limited power supply, while still maintaining network connectivity. This, in turn, provides a better end-user experience. In particular, mobile systems (operating on battery power) or mission-critical servers (operating on UPS power) may benefit from the inclusion of the present invention therein. The present invention provides a system and method for dynamically adapting the link speed of a network adapter to suit the available power supply. By reacting to changes in the available power supply, the device driver for a network controller can make the most efficient use of available power without sacrificing network connectivity.

Under normal operation (i.e., when AC power is available to a system), a device driver for a network controller allows the controller to function at full speed, drawing as much power as necessary from the power source. In preferred embodiments of the present invention, if a system operating on AC power subsequently switches to battery power, the device driver causes the network controller to begin functioning at a slower link speed. This change in link speed reduces the amount of power being consumed by the controller, yet maintains network connectivity. When the system returns to AC power, the device driver preferably then causes the controller to resume operation at full speed. Power consumption at this stage may no longer be at issue, since an infinite supply is again available. Thus, the extra power that is required by the device to operate at a higher network link speed does not adversely affect the potential longevity of system operation.

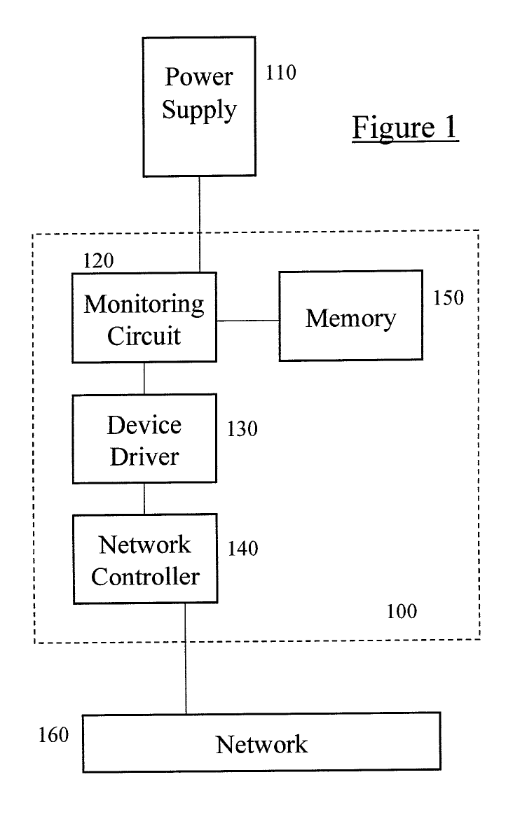

FIG. 1 illustratively depicts the relevant components of a computing system in accordance with an embodiment of the present invention. A computing system 100 may be in electronic communication with a network 160. The computing system may further operate on a power supply 110. The computing system 100 may include a network controller 140 that may facilitate electronic communication between the computing system 100 and the network 160. The computing system 100 may further include a device driver 130 that implements the logic of the present invention and controls functionality of the network controller 140 correspondingly. A monitoring circuit 120 that detects the form and capacity of the power supply 110 may also be included. The monitoring circuit 120 may provide information to the device driver 130 upon query thereby with respect to the form and capacity of the power supply. System memory 150 may be further included such that the logic of the present invention may be stored within the computing system 100.

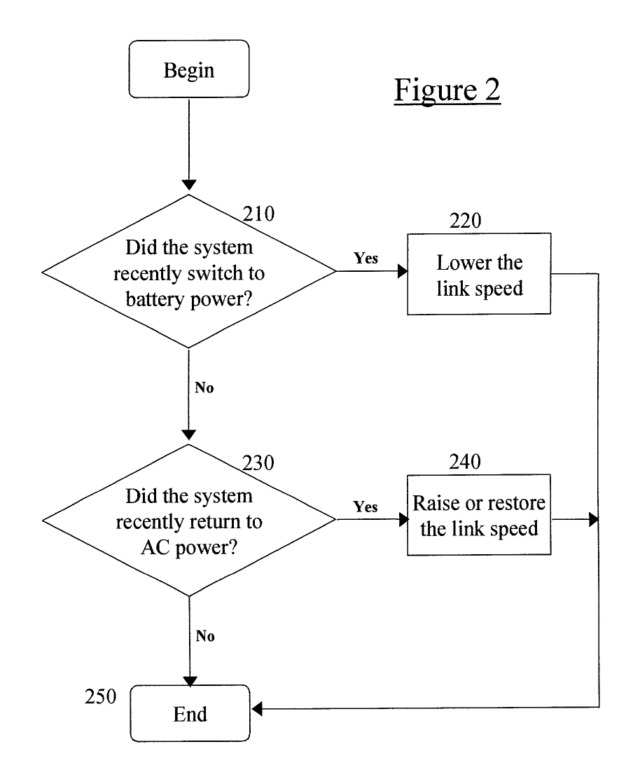

FIG. 2 illustratively depicts a sample implementation of the logic used in accordance with an embodiment of the instant invention. As depicted in FIG. 2, a device driver may execute a periodic maintenance routine. The maintenance routine may be run periodically during system operation as well as upon system start up, or at any other appropriate time. The maintenance routine may first determine 210 if the system has recently switched to battery power. If the system response to this first query 210 is affirmative (i.e., that the system has recently switched to battery power), the driver may respond by lowering the network link speed 220. If the system response to this first query 210 is negative (i.e., that the system has not recently switched to battery power), then the device driver preferably does not alter network link speed.

If the system response to the first query 210 is negative, then the system may secondly determine 230 if the system has recently switched or returned to AC power. If the system response to this second query 230 is affirmative (i.e., that the system has recently switched or returned to AC power), the driver may respond by raising the network link speed 240. If the system was previously operating on AC power, with an interval of operation on battery power thereafter, then raising the network link speed may equate to restoring the link speed to that speed at which the system was previously operating when running on AC power. Alternatively, the link speed may be raised to any speed that is higher than the speed at which the system had been operating when running on battery power. This new, raised link speed may not be the link speed at which the system previously operated when running on AC power (e.g., the system may first run at 100 Mb/s on AC power, then on 10 Mb/s on battery power, and finally at 1,000 Mb/s upon return to AC power). Further, if the answer to the second query 230 is negative (i.e., that the system has not recently switched or returned to AC power), then the maintenance routine may terminate 250, the network link speed being unaffected by the second query.

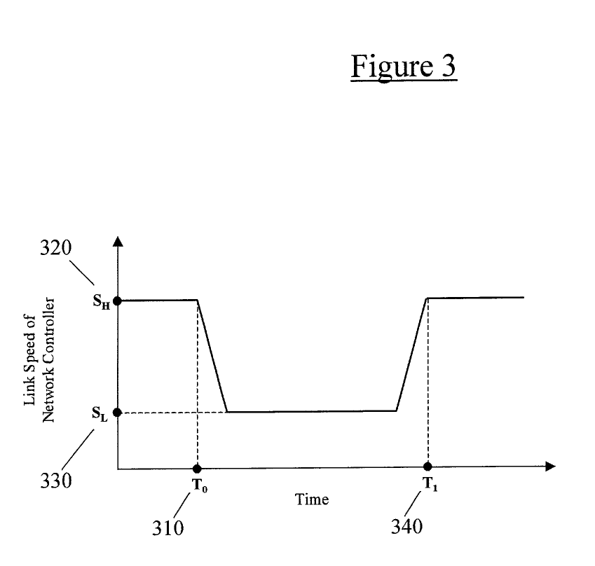

FIG. 3 illustratively depicts a sample behavior of the system over a period of time where the system first operates on an AC power source, then switches to a battery power source, and finally returns to operation on an AC power source. As depicted in FIG. 3, prior to T₀ 310, the system operates at a high link speed S_{H} 320, the power source being an AC power source, or another similar power source of infinite capacity. At T₀ 310, the system preferably switches to battery power (e.g., due to an AC power outage), and the network controller correspondingly switches to a low link speed S_{L} 330. At T₁ 340, the system preferably switches back to AC power (e.g., the AC power is restored), and the network controller correspondingly switches back to a high link speed S_{H} 320. In the embodiment of the present invention illustratively depicted in FIG. 3, the network link speed utilized both prior to T₀ 310 and after T₁ 340 is S_{H} 320, but, as discussed above, these two link speeds need not be equivalent in alternate embodiments of the present invention.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A link speed adjusting system comprising:
a network adapter to provide communication between a computing system and a network, said network adapter operable at more than one link speed;
a network device driver to control functionality of said network adapter; and
a power source to provide power to said computing system,
wherein said network device driver causes said network adapter to switch said link speed to maximize longevity of said power source.

2. The link speed adjusting system of claim 1, wherein said network device driver causes said network adapter to switch from a higher link speed to a lower link speed when said power source changes from an AC power supply to a power source of finite power capacity.

3. The link speed adjusting system of claim 2, wherein said source of finite power capacity is selected from the group consisting of a battery and an Uninterruptible Power System (UPS).

4. The link speed adjusting system of claim 1, wherein said network device driver causes said network adapter to switch from a lower link speed to a higher link speed when said power source changes from a power source of finite power capacity to an AC power source.

5. The link speed adjusting system of claim 4, wherein said source of finite power capacity is selected from the group consisting of a battery and an Uninterruptible Power System (UPS).

6. The link speed adjusting system of claim 1, wherein said power source changes from an AC power source to a source of finite power capacity and then back to said AC power source,
wherein said network device driver causes said network adapter to switch said link speed from a high speed to a low speed upon said change of said power source from said AC power source to said source of finite power capacity, and
said network device driver causes said network adapter to switch said link speed back to said high speed from said low speed upon said change of said power source from said source of finite power capacity back to said AC power source.

7. The link speed adjusting system of claim 6, wherein said source of finite power capacity is selected from the group consisting of a battery and an Uninterruptible Power System (UPS).

8. The link speed adjusting system of claim 1, wherein said network adapter is adapted to operate at link speeds of 10 Mb/s and 100 Mb/s.

9. The link speed adjusting system of claim 1, wherein said network adapter is able to operate at link speeds of 10 Mb/s, 100 Mb/s and 1,000 Mb/s.

10. A method of adapting a link speed of a network controller in a computing system to maximize longevity of a local power supply, comprising:
querying said computing system to determine if said local power supply has recently changed to a source of finite power capacity; and
lowering said link speed if said computing system has recently changed to said source of finite power capacity.

11. The method of claim 10, wherein said source of finite power capacity is selected from the group consisting of a battery and an Uninterruptible Power System (UPS).

12. The method of claim 10, wherein if said computing system has not recently changed to a source of finite power capacity, said method further includes:
querying said computing system to determine if said local power supply has recently changed to an AC power source; and
raising said link speed if said computing system has recently changed to said AC power source.

13. The method of claim 10, wherein said link speed is 10 Mb/s, 100 Mb/s or 1,000 Mb/s.

14. A link speed adjusting system, comprising:
a machine-readable storage medium; and
machine-readable program code, stored on the machine-readable storage medium, the machine-readable program code having instructions to:
query a computing system to determine if a local power supply has recently changed to a source of finite power capacity; and
lower said link speed if said computing system has recently changed to said source of finite power capacity.

15. The link speed adjusting system of claim 14, wherein said machine-readable program code has further instructions to:
query said computing system to determine if said local power supply has recently changed to an AC power source; and
raise said link speed if said computing system has recently changed to said AC power source.

16. The link speed adjusting system of claim 14, wherein said source of finite power capacity is selected from the group consisting of a battery and an Uninterruptible Power System (UPS).

17. The link speed adjusting system of claim 14, wherein said link speed is 10 Mb/s, 100 Mb/s or 1,000 Mb/s.
